(19) United States
(12) Patent Application Publication
(10) Pub. No.: US 2022/0334027 A1
(43) Pub. Date: Oct. 20, 2022

(54) SYSTEMS AND METHODS FOR PREDICTING AND UPDATING GEARBOX LIFETIME EXPECTANCY

(71) Applicant: Dodge Acquisition Co., Oxford, CT (US)

(72) Inventors: Marius Rutkevicius, Raleigh, NC (US); Rajib Mikail, Raleigh, NC (US); Stefan Rakuff, Garner, NC (US); Brandon W. LeRoy, Anderson, SC (US)

(73) Assignee: Dodge Acquisition Co., Oxford, CT (US)

(21) Appl. No.: 17/232,948

(22) Filed: Apr. 16, 2021

(51) Int. Cl. G01M 13/021; G01M 13/04

(52) U.S. Cl. CPC G01M 13/021; G01M 13/04

(57) ABSTRACT

A method for predicting and updating gearbox lifetime expectancies is provided. The method includes: determining, by a computing system, a lifetime expectancy of a gearbox located at a first location; obtaining, by the computing system and from a computing device at the first location, sensor measurements associated with the gearbox; updating, by the computing system, the lifetime expectancy of the gearbox based on the sensor measurements; and causing, by the computing system, display of the updated lifetime expectancy of the gearbox.

### FIELD

The present disclosure relates to gearboxes and, more particularly, to systems and methods for predicting the remaining lifetime of components within gearboxes.

### BACKGROUND

A gearbox (e.g., a gear reducer) is a mechanical device that may reduce the rotational speed and increase the torque generated by an input power source. In some instances, a gearbox may be part of a mechanical power transmission system. For instance, the gearbox may change the speed and the torque of the prime mover (e.g., a motor such as an electric motor) and may be located between the prime mover and a load. Further, the gearbox may be operatively coupled to and/or include a gearbox sensor system. The sensor system may include one or more sensors that are capable of obtaining sensor information (e.g., gearbox usage parameters) such as speed, torque, overhung (radial and axial) forces applied to the input and output shafts, oil quality, and so on. In some examples, a gearbox may achieve its intended effect by having an input gear drive an output gear that has more teeth than the input gear, causing the output gear to rotate more slowly.

Gearboxes may be used for many applications and within many different industries such as food processing, mining, automotive, and agricultural industries. Regardless of the application or industry, unplanned down-time due to gearbox failures can be extremely expensive, for example, due to lost production. Catastrophic gearbox failures can occur, for example, due to mechanical defects, such as breaking of the gear teeth or bearing failures. While, preventive maintenance and inspections can be performed regularly to reduce the probability of unplanned down-time of the gearbox, this incurs undesirable labor costs, requires maintaining spare parts, and necessitates frequent scheduled down-times.

Currently, gearbox condition monitoring is often carried out manually by a field engineer or technician who periodically inspects the gearboxes for unusual behavior. This typically includes performing vibration testing and listening for any unusual acoustic patterns coming from a gearbox, checking the oil fill level and oil condition, and checking the temperature of the oil, bearings and other components. Due to the labor costs, it might not be feasible to carry these inspections out regularly especially due to unforeseen circumstances that may arise. Some users of gearboxes might not carry out any inspections at all and then suddenly experience a catastrophic failure and downtime without any warning signal. Accordingly, there remains a technical need to determine the lifetime expectancy of the gearbox to ensure fewer unplanned down-times.

### SUMMARY

A first aspect of the present disclosure provides a method for predicting and updating gearbox lifetime expectancies. The method includes: determining, by a computing system, a lifetime expectancy of a gearbox located at a first location; obtaining, by the computing system and from a computing device at the first location, sensor measurements associated with the gearbox; updating, by the computing system, the lifetime expectancy of the gearbox based on the sensor measurements; and causing, by the computing system, display of the updated lifetime expectancy of the gearbox.

According to an implementation of the first aspect, the sensor measurements comprise a speed measurement associated with a shaft of the gearbox and updating the lifetime expectancy of the gearbox is based on the speed measurement.

According to an implementation of the first aspect, the sensor measurements comprise a torque measurement associated with a shaft of the gearbox and updating the lifetime expectancy of the gearbox is based on the torque measurement.

According to an implementation of the first aspect, the sensor measurements comprise an overhung force measurement associated with an input or output shaft of the gearbox, and wherein updating the lifetime expectancy of the gearbox is based on the overhung force measurement

According to an implementation of the first aspect, the sensor measurements comprise a vibration measurement associated with the gearbox and updating the lifetime expectancy of the gearbox is based on the vibration measurement.

According to an implementation of the first aspect, the sensor measurements comprise an oil measurement associated with the gearbox and updating the lifetime expectancy of the gearbox is based on the oil measurement.

According to an implementation of the first aspect, the sensor measurements comprise a temperature measurement associated with the gearbox and updating the lifetime expectancy of the gearbox is based on the temperature measurement According to an implementation of the first aspect, updating the lifetime expectancy of the gearbox comprises: updating a lifetime expectancy of a component within the gearbox, wherein the component of the gearbox is a gear, a shaft, or a bearing.

According to an implementation of the first aspect, updating the lifetime expectancy of the component within the gearbox comprises: calculating gear stresses for the gear of the gearbox, determining a fatigue limit for the gear of the gearbox based on the gear stresses; and updating the lifetime expectancy of the gear based on the determined fatigue limit.

According to an implementation of the first aspect, updating the lifetime expectancy of the gear is further based on preexisting gear damage associated with the gear.

According to an implementation of the first aspect, updating the lifetime expectancy of the component within the gearbox comprises: calculating an incremental bearing damage value associated with the bearing of the gearbox, wherein the incremental bearing damage value is based on an L10 value indicating a number of revolutions that the bearing is expected to withstand under a given load; and updating the lifetime expectancy of the bearing based on the incremental bearing damage value.

According to an implementation of the first aspect, the method further comprises: obtaining, by the computing system and from the computing device, new sensor measurements associated with the gearbox, and wherein updating the lifetime expectancy of the gearbox comprises: updating, at a first period of time associated with the sensor measurements, the lifetime expectancy of the gearbox to determine an updated lifetime expectancy based on the sensor measurements; and updating, at a second period of time associated with the new sensor measurements, the lifetime expectancy of the gearbox to determine a second updated lifetime expectancy based on the updated lifetime expectancy and the new sensor measurements.

According to an implementation of the first aspect, updating the lifetime expectancy of the gearbox further comprises: continuously updating the lifetime expectancy of the gearbox throughout an entire service life of the gearbox.

According to an implementation of the first aspect, wherein updating the lifetime expectancy of the gearbox comprises: determining a plurality of lifetime expectancies of a plurality of components within the gearbox based on the sensor measurements associated with the gearbox, wherein the plurality of components within the gearbox comprise one or more gears, one or more shafts, and/or one or more bearings; and determining a new lifetime expectancy of the gearbox based on a smallest value lifetime expectancy, of the plurality of lifetime expectancies, associated with a particular component, of the plurality of components within the gearbox.

According to an implementation of the first aspect, wherein updating the lifetime expectancy of the gearbox is further based on historical data associated with the gearbox, wherein the historical data comprises data indicating an average gearbox measurement value associated with one or more components of the gearbox, wherein the average gearbox measurement value is based on a plurality of sensor measurements from the one or more sensors that were obtained prior to obtaining the sensor measurements associated with the gearbox.

According to an implementation of the first aspect, the method further comprising: generating a load histogram based on historical data associated with a plurality of sensor measurements from the one or more sensors that were obtained prior to obtaining the sensor measurements, wherein the load histogram indicates a plurality of stress ratios associated with the plurality of sensor measurements or a plurality of L10 values associated with the plurality of sensor measurements, and wherein updating the lifetime expectancy of the gearbox is based on the load histogram.

A second aspect of the present disclosure provides a system comprising: a business unit and a back-end computing system. The business unit comprises a gearbox and a computing device. The gearbox comprises one or more sensors that are configured to provide sensor measurements to the computing device. The computing device is configured to: obtain the sensor measurements from the one or more sensors; and provide the sensor measurements to a back-end computing system. The back-end computing system is configured to: determine a lifetime expectancy of the gearbox located at the business unit; obtain, from the computing device, the sensor measurements associated with the gearbox; update the lifetime expectancy of the gearbox based on the sensor measurements; and cause display of the updated lifetime expectancy of the gearbox.

According to an implementation of the second aspect, the back-end computing system is configured to cause display of the updated lifetime expectancy of the gearbox by providing the updated lifetime expectancy of the gearbox to the computing device and the computing device is further configured to display the updated lifetime expectancy of the gearbox.

According to an implementation of the second aspect, the back-end computing system comprises a display device, and the back-end computing system is configured to cause display of the updated lifetime expectancy of the gearbox by displaying the updated lifetime expectancy of the gearbox on the display device.

A third aspect of the present disclosure provides a back-end computing system, comprising: one or more processors; and a non-transitory computer-readable medium having processor-executable instructions stored thereon. The processor-executable instructions, when executed by one or more processors, facilitate: determining a lifetime expectancy of a gearbox located at a first location; obtaining, from a computing device at the first location, sensor measurements associated with the gearbox; updating the lifetime expectancy of the gearbox based on the sensor measurements; and causing display of the updated lifetime expectancy of the gearbox.

### BRIEF DESCRIPTION OF THE DRAWINGS

Embodiments of the present disclosure will be described in even greater detail below based on the exemplary figures. The present disclosure is not limited to the exemplary embodiments. All features described and/or illustrated herein can be used alone or combined in different combinations in embodiments of the present disclosure. The features and advantages of various embodiments of the present disclosure will become apparent by reading the following detailed description with reference to the attached drawings which illustrate the following:

FIG. 1 illustrates a simplified block diagram depicting an environment for predicting gearbox life expectancies according to one or more examples of the present disclosure;

FIG. 2 is a simplified block diagram of one or more devices or systems within the exemplary environment of FIG. 1;

FIG. 3 illustrates an example of a gearbox according to one or more examples of the present disclosure;

FIG. 4 depicts an exemplary process for predicting gearbox life expectancies in accordance with one or more examples of the present application;

FIG. 5 depicts another exemplary process for predicting gearbox life expectancies in accordance with one or more examples of the present application; and

FIG. 6 illustrates an exemplary stress-cycle curve (SN-curve) for gears that is used to determine the fatigue limit for the gears in accordance with one or more examples of the present application.

### DETAILED DESCRIPTION

As mentioned above, traditionally, condition monitoring through periodic inspections using manual or automated methods may be useful for detecting the onset of developing faults of gearboxes before they can lead to a more serious catastrophic failure. This condition-based prediction of gearbox life is one way of performing prognostics to determine whether a gearbox is about to fail. For example, the concentration of metallic particulates in the oil or abnormal vibrations of the gearbox can often be used as an indication for imminent catastrophic failure. However, this approach can only detect the onset of problems and damage that is already occurring. Moreover, this approach does not make predictions about the remaining lifetime of a gearbox. Lifetime in this context may be defined as the time period in which the gearbox components can function as designed. Outside of this time period, the gearbox may still be able to operate but not within the original design and performance parameters (e.g., it may have reduced efficiency).

In contrast, the present application has a different approach to prognostics. In particular, the present application may keep track of the load history using sensors and uses the sensor information to calculate the microscopic damage based on one or more processes. In other words, the damage may be invisible to the naked eye when performing the periodic inspections, but may still be identifiable using high magnification inspection tools (e.g., X-ray crystallography, or electron microscopy). No conventional sensor may be capable of detecting the microscopic damage by itself, but this damage may be determined and/or tracked knowing applied loads. Combined model and sensor information may be used to make lifetime predictions of the gearbox. In other words, to minimize maintenance cost and unexpected downtime, enable smart maintenance and to forecast gearbox maintenance and replacement, the present application describes an automated gearbox usage tracking tool to determine lifetime expectancies of gearboxes. In some instances, the present application may consider many factors affecting gearbox lifetime and the factors may be combined to determine the lifetime expectancy of the gearbox and/or the components within the gearbox. Additionally, and/or alternatively, the present application may determine an overall lifetime prediction of the gearbox and provide information ahead of onset of change in the performance of the gearbox.

Gearbox lifetime expectancy may be a design parameter before manufacturing a gearbox. However, it may be very difficult to accurately design a gearbox for a certain lifetime because the load spectra (e.g., the load(s) driven by the gearbox) are never exactly known. Oftentimes, application factors and some constant rated torque and speed assumptions are used to approximate the real load spectra; however, this may lead to inaccuracies in the lifetime expectancy. For example, a gearbox driving a less demanding load may have a higher lifetime expectancy as compared a gearbox driving a more demanding load. However, without actually knowing the real load spectra for a gearbox, it is difficult to accurately determine and/or predict the gearbox lifetime expectancy.

Further, the life of the gearbox can be limited by various failure modes. Example failure modes include spalling of the races of the rolling element bearings, pitting and micro-pitting of the gear flanks, tooth breakage and scuffing of the gear flanks. Additional failures can occur in shaft seals, shafts, keyways, housings or the lubricants (i.e., lubricant breakdown and contamination). In other words, the components within the gearbox may have their own lifetime expectancies that may further also be based upon the load spectra. Accordingly, the present application may determine the lifetime expectancies of the components (e.g., the bearings, gears, seals, shafts, oil, housing, and so on) within the gearbox.

Exemplary aspects of predicting the lifetime expectancy of gearboxes, according to the present disclosure, are further elucidated below in connection with exemplary embodiments, as depicted in the figures. The exemplary embodiments illustrate some implementations of the present disclosure and are not intended to limit the scope of the present disclosure.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on”.

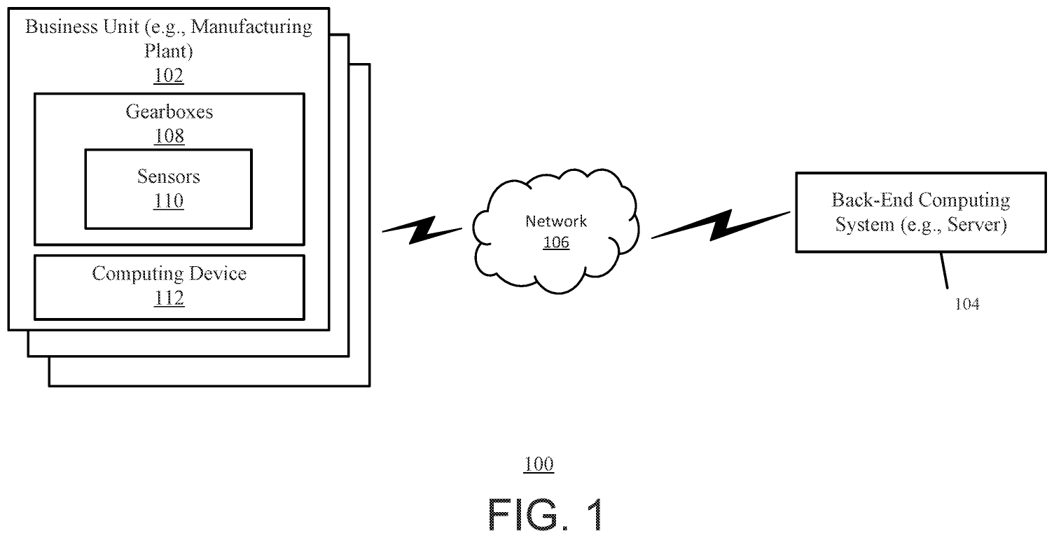

FIG. 1 illustrates a simplified block diagram depicting an environment 100 for predicting gearbox life expectancies according to one or more examples of the present disclosure.

Referring to FIG. 1, environment 100 includes a plurality of business unit 102 (e.g., a manufacturing plant), a network 106, and a back-end computing system 104 (e.g., a server). Each business unit 102 includes one or more gearboxes 108 and a computing device 112. Each of the gearboxes 108 includes sensors 110 that are configured to provide sensor information associated with the particular gearbox 108. Although the entities within environment 100 may be described below and/or depicted in the FIGs. as being singular entities, it will be appreciated that the entities and functionalities discussed herein may be implemented by and/or include one or more entities.

The entities within the environment 100 such as the business unit 102 (e.g., via the computing device 112) and the back-end computing system 104 may be in communication with other systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100. In some instances, the business unit 102 may be in communication with the back-end computing system 104 without using the network 106. For instance, the back-end computing system 104 may be part of a particular business unit 102 and/or the functionalities of the back-end computing system 104 (e.g., determining and/or predicting the life time expectancies of gearboxes 108) may be implemented by the computing device 112. In some examples, the business unit 102 may use one or more communication protocols such as WI-FI or BLUETOOTH and/or a wireline (e.g., Ethernet) to communicate with the back-end computing system 104.

The business unit 102 may be any type of building, establishment, location and/or facility that includes at least one gearbox 108. For example, the business unit 102 may be a manufacturing plant and/or an industrial center that produces goods such as a food processing facility or a mine. The business unit 102 may include one or more gearboxes 108 and use the gearboxes 108 to produce the goods. Each of the gearboxes 108 may be operatively coupled to a prime mover (e.g., an electric motor) and a load. When designing and manufacturing the gearbox, the load that is driven by the gearbox may be estimated and not known. For example, in a food processing facility, gearboxes 108 may be used to operate a conveyor belt as well as some heavy manufacturing equipment such as packing machinery. Operating one load (e.g., heavy manufacturing equipment) may cause more stress on the components of the gearbox as compared to another load (e.g., a conveyor belt). However, during the manufacturing and design phase of the gearbox, the usage of the gearbox may be approximated or might not be known at all and a life expectancy of the gearbox is typically calculated based on an estimated load and not readily updated. Furthermore, shutdowns may occur where the gearbox might not be used. For instance, due to demand, a production line may shut down for a period of time. Since the gearbox is not being used during the shutdown, the life expectancy of the gearbox may increase. As such, as will be explained in further detail below, the environment 100 may be able to account for the above factors, as well as others, to predict and update a life expectancy of a gearbox based on sensor measurements.

The gearbox 108 includes one or more sensors 110. The sensors 110 may be associated with and/or include, but are not limited to, torque sensors, speed sensors, temperature sensors (e.g., thermocouples, RTDs), overhung force sensors, vibration sensors (e.g., piezoelectric accelerometers, laser vibrometers), strain gauges, acoustic sensors (e.g., microphones), oil parameter sensors (e.g. optical sensors, resonant or conductive sensors), proximity sensor, and/or humidity sensors. The sensors 110 may be configured to provide sensor information associated with the gearbox 108 to devices and/or systems within the environment 100 such as the computing device 112 and/or the back-end computing system 104. For example, the sensors 110 may include a torque sensor that measures and provides torque measurements of one or more shafts and/or components within the gearbox 108. For instance, the torque sensor may provide a torque measurement of an input shaft or an output shaft of the gearbox 108.

Additionally, and/or alternatively, the sensors 110 may include a speed sensor that measures and provides one or more speeds (e.g., revolutions per minute (RPM)) of particular components within the gearbox 108.

Additionally, and/or alternatively, the sensors 110 may include an overhung force sensor that measures and provides an overhung force measurement (e.g., a force exerted by an overhung force) for the gearbox 108. An overhung force may be a force placed on an output and/or input shaft of the gearbox 108 due to radial, angular (i.e., tilt), or axial misalignments of the shaft with another shaft, drivebelts or chains used with the gearbox, and/or other factors that cause a radial or axial force to be applied to the output shaft of the gearbox 108 during the operation of the gearbox 108.

Additionally, and/or alternatively, the sensors 110 may include a vibration sensor such as an accelerometer that measures and provides a vibration measurement for the gearbox 108. The vibration sensors can be attached to the outer or inner surfaces of the gearbox housing and measure structural vibrations of the housing. The gearbox housing may also be a preferable location to detect vibrations of the entire gearbox on the system level consisting of vibrations due to bearings, shafts, gears, seals, or other subassemblies.

Additionally, and/or alternatively, the sensors 110 may include a strain gauge/sensor that measures and provides a strain (i.e. deformation) measurement associated with the gearbox 108. The strain gauges are preferably mounted at locations on the gearbox housing that experience maximum strain (or maximum deformation) when the gearbox is loaded with a torque or an overhung shaft force. Typically, the preferred mounting location would be found by means of structural finite element analysis (FEA) or experimentally with many strain measurements. In order to determine the gearbox loads (overhung forces and torques) with strain gauge sensors, the strain gauge sensors may be calibrated with known forces and torques for a particular sensor location and a particular gearbox housing. Once calibrated, the output of the strain gauge sensors is used to deduct the loads (i.e., overhung forces or torques). It should be noted that the housing strains may be measured along different directions at a given location, and that torque and overhung forces may produce distinctively different strain fields. Further, strains may be affected by housing deformation due to thermal expansion/contraction, and temperature compensation may be used to account for temperature-induced deformations.

Additionally, and/or alternatively, the sensors 110 may include an acoustic sensor that measures and provides an acoustic or sound measurement for the gearbox 108. For instance, the acoustic sensor may include a microphone and measure a sound frequency and/or a noise level of the gearbox 108 during operation. The microphone measures sound pressure emitted by the gearbox 108. In some instances, the acoustic sensor may be free-field microphones that are optimized for situations where there are no sound reflections and that measure sound emitted by a single source. In other instances, the acoustic sensor may be other types of microphones.

Additionally, and/or alternatively, the sensors 110 may include an oil parameter sensors that measures and provides an oil parameter measurement for the gearbox 108. For instance, the oil parameter measurement may be a level, volume, or quality reading of the oil of the gearbox 108. Oil properties include oil viscosity, particulate contamination concentration, water content, oil oxidation level, soot, total acid and base numbers, temperature. Parameters such as electrical, optical, and thermal can be used to measure these properties.

Additionally, and/or alternatively, the sensors 110 may include a humidity sensor that measures and provides a humidity measurement for the gearbox 108 and/or the area surrounding the gearbox 108.

The sensors 110 provide sensor data (e.g., sensor measurements) to the computing device 112. The computing device 112 may be and/or include, but is not limited to, a desktop, laptop, tablet, gateway, mobile device (e.g., smartphone device, or other mobile device), an internet of things (TOT) device, or any other type of computing device that generally comprises one or more communication components, one or more processing components, and one or more memory components. The computing device 112 may be capable of obtaining the sensor data from the sensors 110 and providing the sensor data to another device or system within environment 100 such as the back-end computing system 104. For instance, the computing device 112 may include a network interface that is capable of providing information, via the network 106, to the back-end computing system 104.

The back-end computing system 104 obtains the sensor information from the business unit 102 (e.g., the computing device 112) and uses the sensor information and/or additional information to calculate and/or update a lifetime expectancy for one or more gearboxes 108. Afterwards, the back-end computing system 104 may provide information such as the updated lifetime expectancy of the gearboxes 108 to the business unit 102. As shown, environment 100 may include a plurality of business units 102 and each of the business units may include their own gearboxes 108, sensors 110, and/or computing devices 112. The back-end computing system 104 may obtain sensor information for gearboxes 108 of one or more business units 102 and provide the determined lifetime expectancies back to the business units 102. The lifetime expectancies may be provided by the gearbox service provider, which may or may not belong to and/or be associated with the business unit 102. The gearbox service provider may additionally and/or alternatively provide installation or maintenance service for the gearbox 108.

The back-end computing system 104 includes one or more computing devices, computing platforms, systems, servers, processors, memory and/or other apparatuses capable of determining lifetime expectancies of the gearboxes 108. In some variations, the back-end computing system 104 may be implemented as engines, software functions, and/or applications. In other words, the functionalities of the back-end computing system 104 may be implemented as software instructions stored in storage (e.g., memory) and executed by one or more processors.

In some instances, the back-end computing system 104 may have the functionality of following and accounting for a part of and/or the entire service life of the gearbox 108. For instance, the back-end computing system 104 may determine/calculate an initial lifetime expectancy of the gearbox 108 when the gearbox 108 first begins operation. Then, the back-end computing system 104 may continuously and/or periodically update the lifetime expectancy of the gearbox 108 throughout the service life of the gearbox. For example, the gearbox 108 may be powered on using a wire, battery, energy harvesting, and/or other means. When the gearbox 108 is operational, the gearbox 108 and/or the sensors 110 may provide information to the back-end computing system 104. The back-end computing system 104 may begin determining and/or updating the lifetime expectancy of the gearbox 108 based on powering on the gearbox 108. In some variations, the sensors 110 may reach their end of life before the gearbox reaches its end of life. In such variations, the sensors 110 may be replaced and the continuation of the gearbox lifetime measurement may be ensured by the same back-end computing system 104 (e.g., no information about gearbox life may be lost when one of the sensors 110 fails prior to the gearbox 108 failing).

It will be appreciated that the exemplary environment depicted in FIG. 1 is merely an example, and that the principles discussed herein may also be applicable to other situations—for example, including other types of devices, systems, and network configurations. For example, in other instances, the functionalities of the back-end computing system 104 may be performed at a computing device within the business unit 102. For instance, the computing device 112 may be capable of obtaining the sensor information from the sensors 110 and determining/updating a lifetime expectancy of a gearbox 108. Further, in yet other instances, the back-end computing system 104 may communicate with the gearboxes 108 without the assistance of the computing device 112. For instance, the gearboxes 108 and/or the sensors 110 may be capable of providing the sensor measurements via the network 106 to the back-end computing system 104.

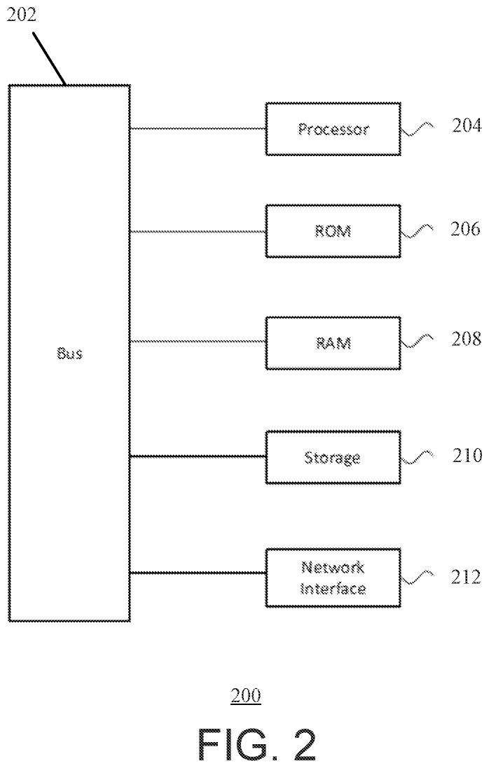

FIG. 2 is a block diagram of an exemplary system and/or device 200 (e.g., the computing device 112 and/or the back-end computing system 104) within the environment 100. The device/system 200 includes a processor 204, such as a central processing unit (CPU), controller, and/or logic, that executes computer executable instructions for performing the functions, processes, and/or methods described herein. The processor 204 is not constrained to any particular hardware, and the controller's configuration may be implemented by any kind of programming (e.g., embedded Linux) or hardware design—or a combination of both. For instance, the processor 204 may be formed by a single processor and/or controller, such as a general purpose processor with the corresponding software implementing the described control operations. On the other hand, the processor 204 may be implemented by specialized hardware, such as an ASIC (Application-Specific Integrated Circuit), an FPGA (Field-Programmable Gate Array), a DSP (Digital Signal Processor), or the like.

In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200.

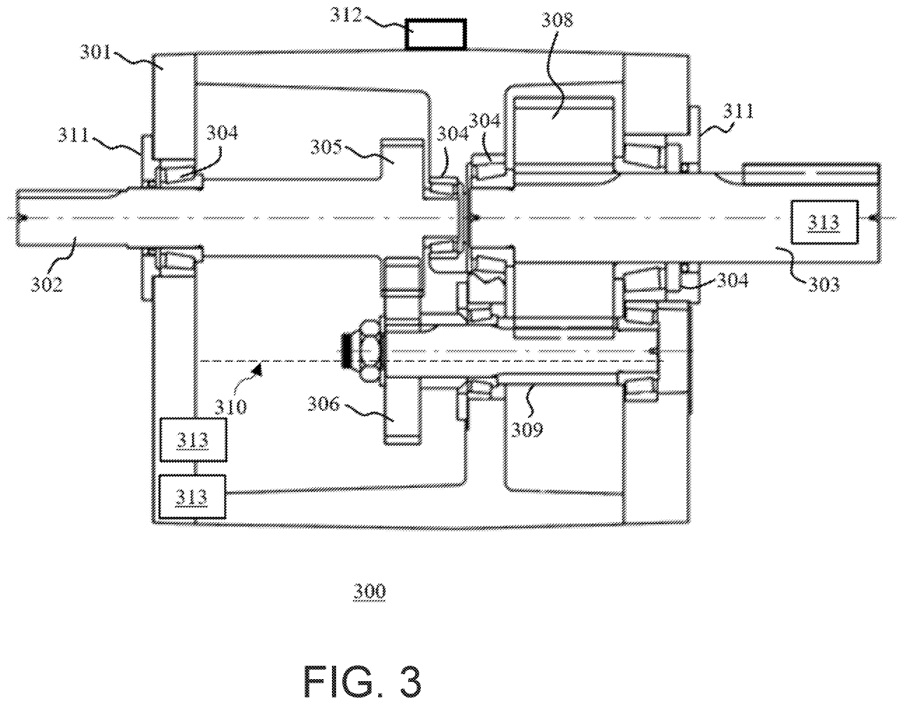

FIG. 3 illustrates an example of a gearbox 300 such as gearbox 108 shown in FIG. 1 according to one or more examples of the present disclosure. The gearbox 300 may be a concentric gear reducer (i.e., with concentric input shaft 302 and output shaft 303). Embodiments of the present application are not limited to a particular design of gearbox, but can be applied to a variety of types and configurations of gearbox (or other types of gear reducers and/or machinery). For instance, in other examples, the gearbox may be a QUANTIS gearbox, MAXUM gearbox, MAGNAGEAR gearbox, TORQUE ARM gearbox, and other types of gearboxes.

The gearbox 300 has a housing 301 enclosing the kinematic components (e.g., shafts, gears, bearings, etc.) of the gearbox 300.

The gearbox 300 includes an input shaft 302 and an output shaft 303. These shafts (302, 303) are partially protruding out of the housing 301 so that they can be operatively coupled to other devices (e.g., a prime mover and/or a load).

In operation, the input shaft 302 may be operatively coupled to a prime mover (e.g., an electric motor) and the output shaft 303 may be operatively coupled to driven equipment or load (e.g., the conveyor, feeder, and/or mill). The gearbox 300 may be configured to reduce the rotational speed at the input shaft 302 to output a lower speed at the output shaft 303 and to increase the torque applied to the input shaft 302 to output a higher torque at the output shaft 303.

The gearbox 300 includes a plurality of bearings 304. The bearings 304 are between the shafts (302, 303, and 309) and the housing 301, and both translationally affix the shafts (302 and 303) within the housing 301 and allow the shafts to rotate. The bearings 304 are typically rolling element bearings. There are many different types of rolling element bearings such as tapered roller bearings, cylindrical roller bearings, and ball bearings.

Several gears (305, 306, and 308) are affixed to the input shaft 302, an intermediate shaft 309, and an output shaft 303. The teeth of adjacent gears operationally mesh with each other such that the rotation of the input shaft 302 results in the intermediate shaft 309 and the output shaft 303 also rotating. The gears have particular characteristics, such as a pitch circle diameter, a working diameter, and number of teeth. By adjusting the characteristics of the gears, various reductions in speed and increases in torque can be achieved. For example, if a first gear 305 has fewer teeth than a second gear 306, then the intermediate shaft 309 will have a lower rotational speed as compared to that of the input shaft 302.

The housing 301 may also contain oil for lubrication and cooling the kinematic components of the gearbox 300. The oil may be filed to a defined oil level 310. Seals 311 are located at the openings for the input shaft 302 and the output shaft 303 to seal the interior of the housing 301.

Each of constituent components of the gearbox 300 may eventually have mechanical defects, which can result in a failure of the gearbox 300, including a minor failure (e.g., a reduction in operating performance) and a catastrophic failure (e.g., a failure which results in the complete loss of function). Such mechanical defects can develop over time (e.g., due to age, wear caused by particulates in the oil, scuffing of contacting gear tooth flanks due to high specific sliding speeds, or fatigue from a high number of cyclic stresses), or may be latent defects originating from the manufacturing process of the component, material imperfections of the components, or the assembly of the gearbox 300. Furthermore, minor defects may grow to become more severe over time.

Gearboxes 300 can fail catastrophically if defects within the gearbox 300 are not detected in time. A catastrophic gearbox failure implies that the gearbox is no longer able to function as intended, and mechanical power from a prime mover (e.g. an electric motor) can no longer be transmitted to a load (e.g., a conveyor belt or a pump). The catastrophic failure of the gearbox can lead to a dangerous condition where the motion of a load can no longer be controlled. Accordingly, the entire and/or a partial operation of the business unit 102 may stop. For example, the gearbox 300 may be on a production line and due to the failure, the production line may encounter an unplanned shut down, which may be costly for the business unit 102. As such, as will be described below, the back-end computing system 104 may determine the lifetime expectancy of gearboxes such as gearbox 108 and/or 300 so as to prevent the production line from encountering many unplanned shut downs.

Two of the main component categories in a gearbox that often show signs of defects are the gears (such as, gears 305, 306, and 308) and the bearings (such as, bearings 304).

Common categories of gear defects include wear, scuffing, plastic deformation, fatigue, cracking and other damage (see e.g., ANSI/AGMA 1010-F14 describing these categories of gear defects, the entire contents of which is hereby incorporated by reference herein). Examples of failures originating from these defects include, gears developing a tooth root crack that can lead to a fracture of the gear tooth, or plastic deformation of gears that becomes sufficiently large so that gear meshing is no longer possible. Defects of most any type, however, can ultimately lead to catastrophic failure of the gearbox. For example, fragments of failing defective components can cause a series of cascading events that result in further damage and ultimately lead to a catastrophic failure.

A similar set of defect categories can be defined for the rolling element bearings as well. Also, as with the gears, minor defects may develop into significant problems. For example, a rolling element bearing can have a small initial defect located on the inner bearing ring. In operation, the small defect can grow over time, cracks can form and move to the surface of the inner bearing ring, pieces of metal can separate, and the severely damaged inner bearing ring and the metal debris can cause bearing seizure.

Gears and bearings are not the only source of defects and device failure. For example, fatigue failure due to cyclic loading of the (rotating) shafts (such as shafts 302, 303, and 309) can also be a problem. The fatigue failure may develop as a fracture of the shaft, which can occur in areas of high stress concentrations (such as keyways, splines or corners). Another example includes misalignment of the motor and the gearbox 300 input shaft 302 that can lead to defects and eventual failure of the shaft coupling or the bearings due to high radial and axial loads, moment loads, and temperatures. Shaft seal failures and loss of oil can lead to problems from lack of lubrication. Lubrication problems can also occur with excessive heat or oil contamination.

Gearbox 300 defects (and failures) are often accompanied by other kinds of symptoms being expressed by the gearbox 300 (such as, excessive vibrations, acoustic emissions, abnormal temperatures, etc.). As such, gearbox sensors (e.g., sensors 110) may detect these expressions of symptoms (e.g., abnormal temperatures, vibrations, and/or acoustical emissions), and the back-end computing system 104 may make predictions regarding the lifetime expectancy of the gearbox.

For example, FIG. 3 illustrates an external sensor 312 (e.g., an accelerometer) on the housing 301 and internal sensors 313. It should be appreciated that the sensors 312 and 313 are merely exemplary and the gearbox 300 may include additional and/or alternative sensors as described above. In some instances, the external sensor 312 may measure vibrations (e.g., housing vibrations due to shaft vibrations, and so on). The bandwidth and sensitivity of the sensor 312 can be chosen so that the frequency of the gear mesh and the bearings and vibrational modes of the gearbox housing can be captured.

In some instances, sensors may be removable from the gearbox 300, and the operational data may be taken at certain times (e.g., as part of a monthly/weekly inspection) rather than on a continuous basis. In other instances, the sensors may continuously provide data to the computing device 112 and/or the back-end computing system 104.

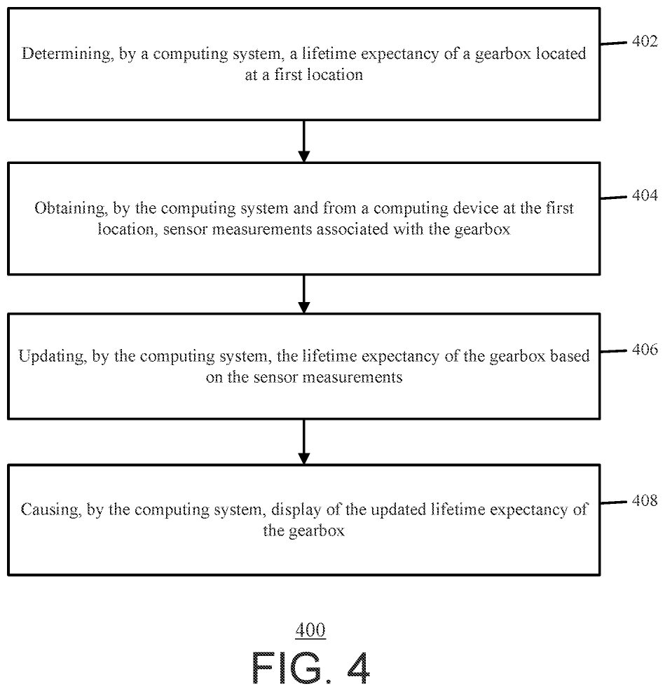

FIG. 4 depicts an exemplary process 400 for predicting gearbox life expectancies in accordance with one or more examples of the present application. The process 400 may be performed by the back-end computing system 104 shown in FIG. 1. However, it will be recognized that any of the following blocks may be performed in any suitable order and that the process 400 may be performed in any environment and by any suitable computing device.

At block 402, the back-end computing system 104 determines a life expectancy of a gearbox (e.g., gearbox 108) located at a first location (e.g., a business unit 102). The life expectancy of the gearbox may indicate an estimated run-time of the gearbox prior to failing and/or being replaced. In some instances, the gearbox may be designed with a particular life expectancy in mind such as remaining in operation for 5,000 hours or in some instances, much longer, such as 7 years. The back-end computing system 104 may receive information associated with the gearbox such as the life expectancy of the gearbox. For instance, a particular manufacturer may produce certain gearboxes and provide information such as a lifetime expectancy of the gearbox. In such instances, when designing the gearbox, the manufacturer may perform tests on the gearbox in order to determine how long the gearbox is expected to last prior to failing. The back-end computing system 104 may receive this information via the network 106. However, as mentioned above, the testing environment, including the loads used to test the gearbox, may be different from the actual environment such as when the gearbox is operating at the business unit 102. For instance, during testing, a constant load may be applied, but in the actual environment, a heavier and/or inconsistent load (e.g., a load that applies a substantial radial force on the output shaft) may be applied to the gearbox, which may greatly reduce the life expectancy of the gearbox. Accordingly, as will be described below, process 400 may be used to determine an actual life expectancy of the gearbox when taking into account factors from the actual environment.

In some instances, the back-end computing system 104 may determine the life expectancy of the gearbox 108 based on receiving information from the first location such as the business unit 102. For instance, the computing device 112 may provide information indicating a life expectancy (e.g., 5,000 hours) for a particular gearbox 108. In some instances, an engineer or technician at the business unit 102 may conduct an inspection of the gearbox 108 and review material associated with the gearbox 108. Subsequently, the engineer or technician may use the computing device 112 to provide information indicating the life expectancy of the gearbox 108.

In some examples, the process 400 may be iteratively repeated. In other words, the back-end computing system 104 may continuously and/or periodically receive sensor measurements from the sensors 110 indicating conditions of the gearbox 108. Based on the sensor measurements, the back-end computing system 104 may determine an updated lifetime expectancy of the gearbox 108 and/or store it within memory (e.g., storage 210). Then, in the next iteration, at block 402, the back-end computing system 104 may determine the life expectancy of the gearbox 108 based on retrieving the previously determined lifetime expectancy of the gearbox 108 from memory. The frequency of these measurements may be several times per second, several times per day, several times per year, and/or other frequencies.

At block 404, the back-end computing system 104 obtains, from a computing device (e.g., computing device 112) at the first location, sensor measurements associated with the gearbox (e.g., gearbox 108). For example, the sensors 110 may detect sensor measurements (e.g., an RPM and/or a torque measurement) of the gearbox 108. The sensors 110 may provide the detected sensor measurements to the computing device 112 and the computing device 112 may provide the sensor measurements to the back-end computing system. As mentioned previously, the sensors 110 may be associated with and/or include, but are not limited to, torque sensors, speed sensors, temperature sensors, overhung force sensors, vibration sensors, strength gauges/sensors, acoustic sensors, oil parameter sensors, and/or humidity sensors. Based on these sensors 110, the back-end computing system 104 may obtain one or more torque measurements, speed measurements, temperature measurements, overhung force measurements, vibration measurements, strength gauge measurements, acoustic measurements, oil parameter measurements, and/or humidity measurements.

In some instances, the back-end computing system 104 may receive additional and/or alternative sensor measurements and/or information. For instance, the sensors 110 may include one or more electrical sensors that are configured to measure electrical characteristics (e.g., current, voltage, and/or power, speed, torque, frequency) of the prime mover (e.g., motor). The back-end computing system 104 may use these electrical characteristics in place of or in addition to the torque sensor and the torque measurements. Additionally, and/or alternatively, the back-end computing system 104 may receive information such as design parameters of the gearbox (e.g., information about the design, the material the gearbox is made from, the dimension of the gearbox, the relationship of the gears to each other, and so on) and/or specific material fatigue life (e.g., a first material may have a different life expectancy than a second material).

At block 406, the back-end computing system 104 updates the lifetime expectancy of the gearbox based on the sensor measurements. For instance, the back-end computing system 104 may update the determined lifetime expectancy of the gearbox 108 from block 402 using the sensor measurements from block 404. In some instances, the back-end computing system 104 may reduce the lifetime expectancy of the gearbox 108 based on the sensor measurements. For example, the back-end computing system 104 may receive sensor measurements indicating a temperature reading and/or a vibration/acoustic reading of the gearbox 108. Based on the readings, the back-end computing system 104 may reduce the lifetime expectancy of the gearbox 108. In other instances, the back-end computing system 104 may increase and/or keep constant the lifetime expectancy of the gearbox 108. For instance, the back-end computing system 104 may receive sensor measurements indicating that the speed (e.g., RPM) of the gearbox 108 is substantially at zero for a significant period of time. In other words, the business unit 102 may be a manufacturing plant with a production line being down. Since the production line is down, the gearbox 108 might not be in operation. Accordingly, the back-end computing system 104 may increase and/or keep constant the determined lifetime expectancy of the gearbox 108.

The back-end computing system 104 may use one or more of the sensor measurements to update the determined lifetime expectancy of the gearbox 108. For instance, the computing system 104 may receive a single sensor measurement (e.g., the speed) from the computing device 112 and use the single sensor measurement to update the determined lifetime expectancy. In other instances, the computing system 104 may use a combination of two or more (e.g., three) sensor measurements (e.g., speed, torque, and overhung force) to update the determined lifetime expectancy. In some examples, the computing system 104 may or might not use all of the received sensor measurements from the computing device 112. For example, the computing system 104 may receive eight different sensor measurements and may use a combination of three of these sensor measurements and/or all eight sensor measurements to update the lifetime expectancy.

In some examples, the back-end computing system 104 may determine and/or update lifetime expectancy of particular components within the gearbox 108. For instance, referring to FIG. 3, the back-end computing system 104 may determine and/or update the lifetime expectancy of the individual bearings 304 and/or gears 305, 306, and 308 based on the sensor measurements. For instance, at block 402, the back-end computing system 104 may determine a lifetime expectancy for a bearing or a gear such as gear 306. Based on the sensor measurements such as speed or torque, the back-end computing system 104 may update the lifetime expectancy such as reduce the lifetime expectancy for the bearing or the gear (e.g., gear 306).

In some variations, each of the bearings, gears, and/or other components of the gearbox 108 may have a different lifetime expectancy. For instance, the gear 306 may be made from a first material and have a lifetime expectancy of 3,000 hours whereas the gear 308 may be made from a second material and have a lifetime expectancy of 5,000 hours. The back-end computing system 104 may update the lifetime expectancy for each of the components of the gearbox 108. For instance, using the sensor measurements, the back-end computing system 104 may first update the lifetime expectancy for gear 306, then the lifetime expectancy for gear 308, and then the lifetime expectancy for one of the bearings 304. Additionally, and/or alternatively, the components of the gearbox 108 may be of different sizes and operate at different speeds, which might cause certain components more stress and/or damage as compared to other components. Accordingly, the back-end computing system 104 may update (e.g., reduce) the lifetime expectancy for a particular component (e.g., gear 306) different from another component (e.g., gear 308). In some examples, the back-end computing system 104 may determine the lifetime expectancy of the gearbox 108 as the lifetime expectancy of a particular component that has the lowest lifetime expectancy remaining. For instance, the gears 305, 306, and 308 may have 1,000 hours, 2,000 hours, and 3,000 hours of lifetime expectancy remaining, respectively. The back-end computing system 104 may determine the lifetime expectancy of the gearbox 108 as the lifetime expectancy of the component with the lowest lifetime expectancy remaining (e.g., the gear 305 with the lifetime expectancy of 1000 hours).

In some instances, the back-end computing system 104 may use a model, algorithm, and/or other process to update the lifetime expectancy of the gearbox 108 and/or the components of the gearbox 108. For instance, the back-end computing system 104 may input the sensor measurements into a model (e.g., a physics model) and the model may output information such as the forces, stresses, and/or damage caused for each cycle (e.g., a certain period time). The back-end computing system 104 may update the lifetime expectancy of the gearbox 108 and/or the components of the gearbox 108 based on the output information.

At block 408, the back-end computing system 104 causes display of the updated lifetime expectancy of the gearbox (e.g., gearbox 108). For instance, the back-end computing system 104 may display the updated lifetime expectancy on a display device associated with the back-end computing system 104. For instance, the back-end computing system 104 may include a display/display device and may display the updated lifetime expectancy of the gearbox. Additionally, and/or alternatively, the back-end computing system 104 may provide information to the computing device 112 and/or another device. The information may indicate a lifetime expectancy of the gearbox 108 and/or one or more lifetime expectancies of the components of the gearbox 108. For instance, the information may indicate the lowest lifetime expectancy for a particular component of the gearbox (e.g., the gear 306 has a lifetime expectancy of 100 hours). Additionally, and/or alternatively, the back-end computing system 104 may provide instructions to the computing device 112 and/or another device to cause the computing device 112 to display the updated lifetime expectancy of the gearbox 108 and/or the components of the gearbox 108.

In some examples, process 400 may be performed iteratively (e.g., at certain evaluation intervals). For instance, the back-end computing system 104 may continuously and/or periodically obtain sensor measurements and update the lifetime expectancies of the gearbox 108 and/or the components of the gearbox 108. For example, in the first iteration (e.g., first evaluation interval), the back-end computing system 104 may reduce the lifetime expectancy of gear 306 from 5,000 hours to 4,960 hours based on the sensor measurements. In the next iteration (e.g., second evaluation interval), this may be decreased to 4,940 hours and so on. By performing process 400 iteratively, the back-end computing system 104 may take into account factors such as shutdowns and/or increased load applications of the gearbox 108. As such, the back-end computing system 104 may provide a more accurate lifetime expectancy of the gearbox 108 and/or the components of the gearbox 108.

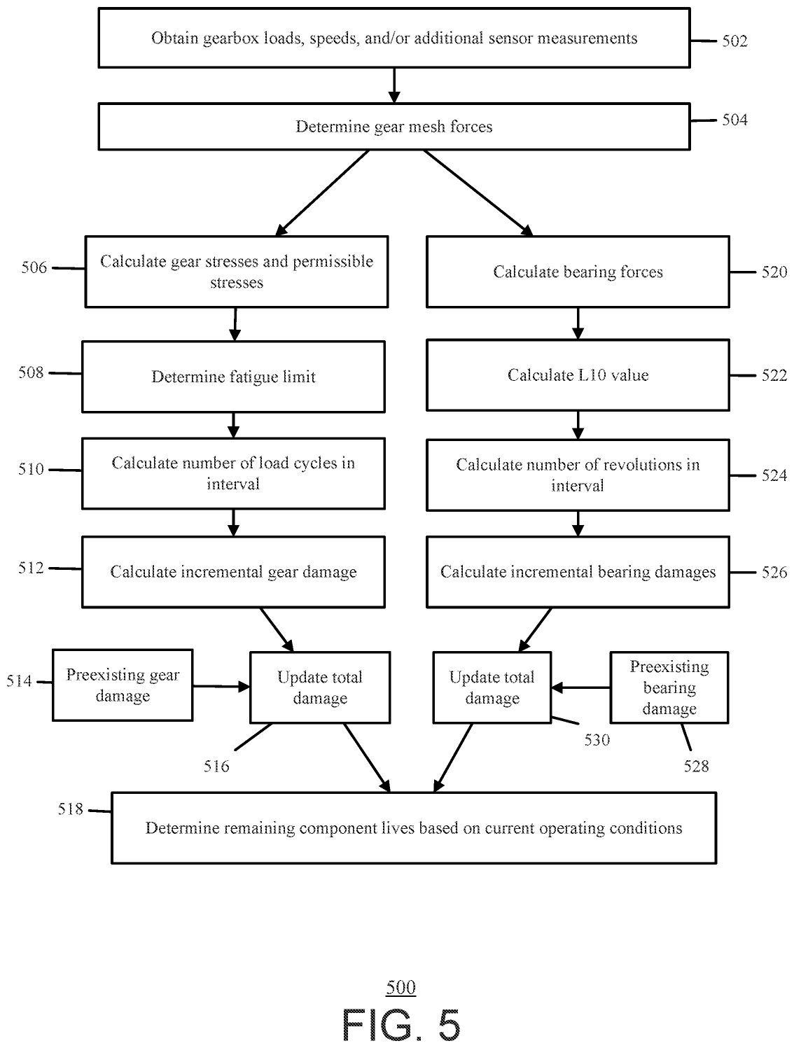

FIG. 5 depicts an exemplary process 500 for predicting gearbox life expectancies in accordance with one or more examples of the present application. The process 500 may be performed by the back-end computing system 104 shown in FIG. 1. However, it will be recognized that any of the following blocks may be performed in any suitable order and that the process 500 may be performed in any environment and by any suitable computing device.

In particular, process 500 may describe several blocks (e.g., blocks 404 and 406) of process 400 in further detail. Further, as mentioned previously, process 400 may be performed iteratively. Similarly, process 500 may also be performed iteratively. For example, process 500 may be performed at an evaluation interval (e.g., a particular time period) to determine lifetime expectancies of components within the gearbox 108. After completion of process 500 and referring back to FIG. 4, the computing system 104 may cause display of the updated lifetime expectancy of the gearbox as described in block 408. Additionally, and/or alternatively, process 500 may repeat such that it begins a new evaluation interval for the gearbox. In some instances, process 500 may be performed similar to a WHILE loop and may begin as soon as the gearbox 108 is installed and in operation. The WHILE loop may have a timed (of known value, constant or non-constant) time interval (T), and the blocks of process 500 may be executed repeatedly in the loop until the gearbox is stopped. The time interval T could be made very short if the loads of the gearbox are changing rapidly and made large if the loads of the gearbox are not changing very much. Additionally, and/or alternatively, after one or more iterations of process 500, the back-end computing system 104 may perform block 408 and cause display of the updated lifetime expectancy. The number of the WHILE loop may be denoted by letter i and used as an index to other variables to indicate that they are for the present i-th evaluation interval. This may be important for the calculation of the remaining component lives in block 518. When talking about the other blocks, the index i may omitted with the understanding that the associated variables may also be specific to a particular evaluation interval. i is a positive integer value.

In some instances, process 500 may be used to determine the damage that may impact the life expectancy of the gearbox 108/components of the gearbox 108. For instance, process 500 may be used to determine the gear flank surface fatigue (pitting) of helical gear teeth (e.g., the teeth of the gears 305, 306, and 308) and/or the L10 life of rolling elements bearings such as the deep groove ball bearings and tapered roller bearings (e.g., bearings 304). The L10 life is an estimated number of hours a bearing lasts under a given load and speed. The previous two failure modes (bearing L10 failures and gear tooth surface fatigue or pitting) are merely exemplary and other failure modes of the gears and failure modes of other components, such as shafts, may also be included in the calculations, which is described below. The back-end computing system 104 may use international organization for standardization (ISO) standards, Deutsches Institut für Normung (DIN) standards, American Gear Manufacturers Association (AGMA) standards, and/or other information/standards to determine factors impacting the life expectancy. For instance, the back-end computing system 104 may use the ISO 281 standard, the ISO 6336-1 standard, the ISO 6336-2 standard, the ISO 6336-3 standard, ISO 6336-4 standard, the ISO 6336-5 standard, and/or the ISO 6336-6 standard to determine the factors. The entire contents of these standards (e.g., the ISO 281 standard, the ISO 6336-1 standard, the ISO 6336-2 standard, the ISO 6336-3 standard, ISO 6336-4 standard, the ISO 6336-5 standard, and the ISO 6336-6 standard) are hereby incorporated by reference herein.

Additionally, and/or alternatively, the determined factors may also include other failure mechanisms and/or other components that may fail as well. For instance, the back-end computing system 104 may further determine other failure mechanisms such as gear tooth root fatigue, micro-pitting, scuffing, and/or bending fatigue of shafts. Further, the back-end computing system 104 may determine other components that may fail such as spur gears, helical gears, bevel gears, and/or shafts. The bevel gears may be analyzed as well. The back-end computing system 104 may use the ISO 6336-3 standard, the ISO 6336-4 standard, the ISO 6336-20 standard, the ISO 6336-21 standard, the ISO 6336-22 standard, the ISO 10300-1 standard, and/or the ISO 10300-2 standard to determine the factors. The entire contents of these standards (e.g., the ISO 6336-3 standard, the ISO 6336-4 standard, the ISO 6336-20 standard, the ISO 6336-21 standard, the ISO 6336-22 standard, the ISO 10300-1 standard, and/or the ISO 10300-2 standard) are hereby incorporated by reference herein.

Additionally, and/or alternatively, the present application may further determine additional and/or alternative failure modes and/or other components that may fail, which may be used by the back-end computing system 104 to determine the life expectancy of the gearbox and/or the components of the gearbox.

In operation, at block 502, similar to block 404, the back-end computing system 104 obtains gearbox loads, speeds, and/or additional sensor measurements. For instance, the back-end computing system may obtain and/or derive sensor information from the sensors 110 of the gearbox 108. The sensor information may include, but is not limited to, the torque transmitted by the output shaft of the gearbox 108, the rotational speeds of the input shaft of the gearbox 108, and/or the overhung forces detected (seen) by the input and output shafts of the gearbox 108. In some instances, the gearbox 108 may have one degree of freedom. Therefore, the back-end computing system 104 may use one obtained and/or derived shaft speed value to determine/calculate the other shaft speeds using the gear ratios between the shafts. Additionally, and/or alternatively, the back-end computing system 104 may use one torque value to determine/calculate the other torque values of the gearbox 108 (neglecting the mechanical friction and oil churning losses). In other words, the sensors 110 (e.g., a torque and/or speed sensor) may be placed at different locations within the gearbox 108 (e.g., on different shafts) and the back-end computing system 104 may determine use these sensor measurements to calculate the shaft speeds and/or torque values of the other shafts within the gearbox 108.

In some instances, the back-end computing system 104 may receive user input indicating one or more operating parameters of the gearbox 108. In other words, if an operating parameter is known, then the back-end computing system 104 may receive user input indicating the operating parameter rather than from the sensors 110. Further, if overhung force values are unable to be obtained, the back-end computing system 104 may continue to estimate the lifetime of components within the gearbox 108 that may be unaffected and/or mostly unaffected by the overhung force values.

At block 504, the back-end computing system 104 determines gear mesh forces for the gearbox 108. For instance, the back-end computing system 104 may determine the instantaneous mesh forces between the gears by: a tangential force acting at a gear calculated from the transmitted torque and the working diameter of the gear; the pressure angle of the gear tooth results in a radial force component that is calculated from the tangential force and the pressure angle; and/or the helix angle of the gear tooth results in an axial force component that is calculated from the tangential force and the helix angle. In some instances, each of these forces may be a sum of several smaller forces that act between several teeth that may be in mesh at the same time. This may be true for helical gears that have a high tooth contact ratio.

As will be described below, blocks 506-516 may be directed towards updating the total damage to the gears, and blocks 520-530 may be directed towards updating the total damage to the bearings. For example, at block 506, the back-end computing system 104 calculates the gear stresses for the gears (e.g., gears 305, 306, and 308). For instance, from the gear forces from block 504, the back-end computing system 104 may determine the instantaneous stresses S at each gear of the gear tooth flanks and tooth roots. This is done at block 506. The determination may consider the gear tooth geometries, the manufacturing imperfections, elastic deformations of shafts and gears, the bearing clearances, the dynamics, and/or the running-in effects.

At block 506, the back-end computing system 104 may further calculate the permissible stresses for the gears. For instance, for each gear, the computing system 104 may calculate the instantaneous permissible stress Sₚ based on a material-specific reference stress value Sₗᵢₘ. The reference stress value Sₗᵢₘ may be based on publicized standardized test data. To get Sₚ, the back-end computing system 104 may multiply the reference stress Sₗᵢₘ by correction factors to account for differences between the test conditions and the actual gearbox running conditions. The correction factors account for differences in lubrication, pitch line velocity, and gear tooth flank surface roughness. In some instances, while the correction factor for flank surface roughness may be constant between iterations, the lubrication factor and/or the velocity factors may change.

At block 508, the back-end computing system 104 determines the number of cycles to failure N for the gears. For instance, for each gear, the back-end computing system 104 may determine the cycles to failure N for a particular stress ratio

$$\frac{S}{{S}_{P}}$$

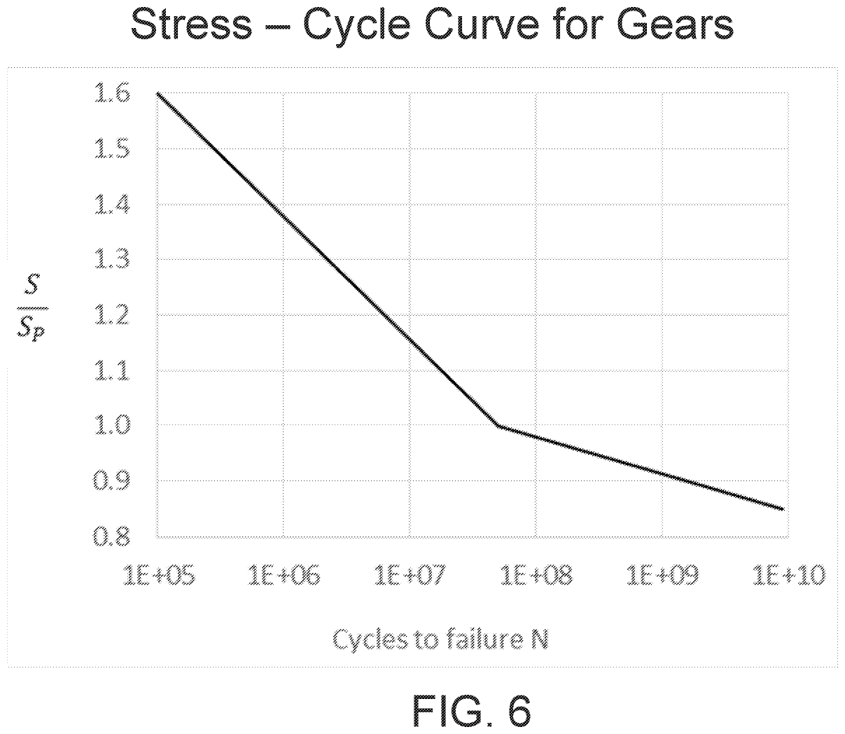

using a stress-cycle curve (SN-curve) for gears. FIG. 6 shows an exemplary SN-curve for gears that is used to determine the cycles to failure N for the gears. In particular, FIG. 6 shows a graphical representation of the stress ratio

$$\frac{S}{{S}_{P}}$$

to the cycles to failure N. The shape of the curve may change based on the geometries of the gears, operating conditions of the gearbox 108, and/or the material of the gears. The cycles to failure N may be the number of cycles after which first signs of surface fatigue (pitting) occur on the surface or it may be the number cycles after which cracks form on the gear tooth root. The SN-curve may be approximated with piecewise linear segments and equations on a log-log scale or with a lookup table. With this format of the SN-curve, the computing system 104 may calculate the cycles to failure Nᵢ for a given stress ratio

$$\frac{{S}_{i}}{{S}_{Pi}}$$

in the current i-th evaluation interval.

At block 510, the back-end computing system 104 calculates a number of stress cycles n in the interval. For instance, given the instantaneous rotational speed of a shaft of the gearbox 108, the number of stress cycles n may be calculated that the gear flanks experience in each loop interval of time T by multiplying T with the rotational speed. The rotational speed may be an averaged value if it changes during the evaluation time.

At block 512, the back-end computing system 104 calculates the incremental gear damage. For instance, an incremental damage value R may be calculated based on the stress cycles n and the number of cycles to failure N (e.g., R=n/N), which may be a small number.

At block 514, the back-end computing system 104 retrieves the preexisting gear damage for the gears (e.g., the preexisting gear damage from the previous iteration/cycle).

At block 516, the back-end computing system 104 updates the total damage to the gears. For instance, the back-end computing system 104 sums up the incremental damages for the iterations. The incremental damages calculated in one iteration are added to damages from previous loop iterations and to any pre-existing damages from previous times the gearbox was run (e.g., the total damages up to the i-th evaluation interval equal: R₁+R₂+R₃+ . . . +Rᵢ=ΣRᵢ) In some instances, when this expression reaches 1, the useful life of the gear flanks is consumed, and onset of pitting or cracking would be expected.

At block 520, the back-end computing system 104 calculates the bearing forces for the bearings using the kinematics of the gearbox. For instance, from the gear forces from block 504, the back-end computing system 104 may determine the instantaneous bearing forces. The bearing forces may be determined based on the physical dimensions of the gearbox components and/or the calculations that are unique to a specific gearbox.

At block 522, the back-end computing system 104 calculates an L10 value based on the bearing forces. The L10 value may be the number of revolutions (in millions) that a bearing is expected to withstand under a given load. It may be based on tests with a large population of identical bearings and a 10 percent failure rate. This statistical data may be available in the public domain from the bearing manufacturers for different bearings, and the back-end computing system 104 may obtain this statistical data from the public domain.

At block 524, the back-end computing system 104 calculates a number of revolutions that occur in the interval. For instance, given the instantaneous rotational shaft speeds of the gearbox 108, the number of revolutions n may be calculated that each bearing sees in each loop interval of time T by multiplying the speeds by T.

At block 526, the back-end computing system 104 calculates the incremental bearing damages. For instance, an incremental damage value B may be calculated based on the L10 value and the number of revolutions

$$( e . g . , B = {10}^{- 6} \frac{n}{{L}_{10}} ) .$$

The factor 10\hat{ }-6 is used since L10 is in the millions of revolutions. B is typically a very small value.

At block 528, the back-end computing system 104 retrieves the preexisting gear damage for the bearings (e.g., the preexisting bearing damage from the previous iteration/cycle).

At block 530, the back-end computing system 104 updates the total damage to the bearings. For instance, the back-end computing system 104 sums up the incremental damages for the iterations. The incremental damages calculated in one iteration are added to damages from previous loop iterations and to any pre-existing damages from other times the gearbox was run (e.g., the total bearing damages up to the i-th evaluation interval equal: B₁+B₂+B₃+ . . . +Bᵢ=ΣBᵢ). In some instances, when this expression reaches 1, the bearing would be expected to fail at 10% probability (which may be considered the end of the useful bearing life).

At block 518, the back-end computing system 104 uses the updated total damages for the gears and bearings to determine the remaining component lives based on the current operating conditions. For instance, to determine the remaining gear tooth flank lives or gear tooth root lives, the back-end computing system 104 may first calculate the remaining stress cycles for each gear. Assuming the instantaneous stresses and stress ratios

$$\frac{S}{{S}_{P}}$$

corresponding to the instantaneous torque (i.e., the torques and stresses at the i-th evaluation interval), the remaining stress cycles nᵣₑₘ are calculated by solving:

$$\sum {R}_{i} + \frac{{n}_{rem}}{{N}_{i}} = 1 ,$$

where Rᵢ is the incremental damage value for a gear during the i-th evaluation interval, ΣRᵢ the sum of all the incremental damage values thus far (i.e., up to present evaluation interval i), and Nᵢ is the number of cycles to failure that corresponds to stress ratio

$$\frac{{S}_{i}}{{S}_{Pi}} .$$

The predicted lifetimes of the gear flanks are calculated by dividing the remaining stress cycles nᵣₑₘ by the rotational speeds of each gear.

For the bearings, the back-end computing system 104 may calculate the predicted remaining revolutions for each bearing by solving:

$$\sum {B}_{i} + {10}^{- 6} \frac{{m}_{rem}}{{L}_{10 i}} = 1 ,$$

where mᵣₑₘ is the remaining bearing revolutions in millions, Bᵢ is the incremental damage value for a bearing, ΣBᵢ the sum of all the incremental damage values thus far, and L10i is the L10 value at the i-th evaluation interval. This may assume the instantaneous operating conditions (speed, torque, overhung forces) of the gearbox 108. In other words, the predicted bearing lifetimes are calculated by dividing the remaining revolutions mᵣₑₘ by the rotational speed of the bearings.

In some instances, the back-end computing system 104 may use empirical relationships/equations that are incorporated into a physics model, which may be executed on PYTHON and/or other programming languages such as MATLAB, OCTAVE, VISUAL BASIC. As the gearbox continues to be used, the lifetime information may be updated by running the calculations and updating the gear stresses continuously. The inputs to determine the lifetime expectancy of the gearbox may include speed, torque, and overhung shafts. Additionally, and/or alternatively, the inputs may further include the gearbox speed (to know the number of stress cycles that the gearbox components were exposed), the gearbox vibration spectrum (to provide the speed and/or may be possible to capture load information), the motor current and voltage (to provide information on loads and speeds), and/or the oil quality (to provide information on wear acceleration, if any).

In some examples, the back-end computing system 104 may determine gear stresses from gear design parameters and gear forces that are results of operating conditions such as torque, overhung forces, speeds, and so on. The back-end computing system 104 may further determine the fatigue life that corresponds to the calculated stress from information such as gear material datasheets. Then, the computing system 104 may determine a Miner's sum using the current time interval, the fatigue life at the calculated stress levels, and the number of cycles at this stress level in the time interval. The Miner's sum may be continuously updated. The speed and stress of each gear or gear pair may be calculated corresponding to the Miner's sum.

In some variations, rather than using the Miner's sum, the back-end computing system 104 may use other lifetime calculation approaches such as the Inverse Power Law. In some instances, the bearing lifetime may be calculated based on the ISO 281 standard and the back-end computing system 104 may calculate the equivalent force on the bearing and use it together with the bearing's load rating to calculate the L10 value.

In some instances, the component with the shorter life may be called the lifetime limiting component (LLC) of the system. For instance, if the torque is low, but the overhung force is high, then input or output shaft bearings may become the LLC of the environment. The back-end computing system 104 may keep track of both remaining life of the bearings and the gears. If the environment changes, for example, overhung force is reduced, then the new stresses on bearings may be lower and gear pairs may eventually become the LLC of the gearbox, which may help the gearbox reach a longer life. Another change of the LLC may be caused by a different design of a gearbox. If the design changes, the underlying physical parameters of the gearbox (such as gear profile) may be adjusted within the model. This may result in different forces and stresses, and potentially different resulting lifetime expectations. In some examples, the back-end computing system 104 may perform certain aspects of process 500 without performing other aspects. For instance, the back-end computing system 104 may determine the lifetime expectancy of the gears for the gearbox 108 (e.g., perform blocks 502-518) without determining the lifetime expectancy of the bearings. In other instances, the back-end computing system 104 may determine the lifetime expectancy of the bearings for the gearbox 108 (e.g., perform blocks 502, 504, 520-530, and 518) without determining the lifetime expectancy of the gears.

In some variations, referring to block 518 in FIG. 5, there may be additional and/or alternative ways of calculating the remaining lifetimes of gearbox components (shafts, bearings, gears) that are not based solely on the present operating conditions (e.g., the operating conditions present during the i-th evaluation interval). For instance, the back-end computing system 104 may use historical operating conditions from prior intervals and/or additional/alternative historical data to determine the remaining lifetime of one or more components of the gearbox (e.g., the bearings, shafts, and/or gears of the gearbox 108). The back-end computing system 104 may use the historical operating conditions and/or historical data in addition to or as an alternative to the current operating conditions in order to determine the remaining lifetime of the components of the gearbox. This may have the effect that the lifetime estimates of the components do not drastically change from one evaluation interval to the next if the operating conditions change. For bearings, the calculation of the remaining bearing revolutions (in millions) mᵣₑₘ may be based on a mean L10 value that is averaged over all evaluation intervals rather than based on the single L10ᵢ value of the i-th interval. The remaining bearing life may be calculated from mᵣₑₘ with the bearing's rotational speed as before. In other words, in some instances, the back-end computing system 104 may determine the remaining lifetime of one or more bearings within the gearbox based on a mean or average L10 value over a plurality of previous iterations of process 500 rather than just solely the L10 value and/or other data of the current iteration of process 500. Similarly, for the gears, the remaining stress cycles nᵣₑₘ may be calculated based on a mean value of N (cycles to failure for a certain stress ratio) that is averaged over all evaluation intervals. The remaining life of the gear may be calculated with the gear rotational speed and nᵣₑₘ as before. In other words, in some variations, the back-end computing system 104 may determine the remaining lifetime of one or more gears within the gearbox based on a mean or average N (cycles to failure for a certain stress ratio) over a plurality of previous iterations of process 500 rather than just solely the values and/or other data of the current iteration of process 500.

In yet other variations, the back-end computing system 104 may determine/calculate the life expectancy remaining of components within a gearbox based on a load histogram that may be generated with data up to the i-th evaluation interval (e.g., the current interval). The future gearbox usage as well as the lifetime expectancy remaining of the components may then be based on this histogram. For example, for gears, the back-end computing system 104 may generate a histogram where the bins of the histogram are formed with the various stress ratios

$$\frac{S}{{S}_{P}}$$

and the vertical axis of the histogram has the number of cycles that each stress ratio was present. For bearings, the histogram bins are formed with the various L10 values that were present in the past, and the vertical axis has the number of revolutions. It should be noted that the order at which the various loads were applied to the gearbox might not matter for the histograms, i.e. the order in which loads were applied is not captured in the histograms. The sums of the incremental damages of the gears (i.e., ΣRᵢ) and of the bearings (i.e., ΣBᵢ) that are continuously being computed by the back-end computing system 104 are a measure of the consumed lifetimes up to the i-th evaluation interval. For example, if the numerical value of ΣRᵢ for a given gear equals 0.25, then 25 percent of the gear's fatigue life has been consumed. Similarly, if the numerical value of ΣBᵢ equals 0.5, then 50 percent of the lifetime of a bearing has been consumed. The consumed lifetime percentages of the components (gears and bearings) correspond to the total time (i.e., the sum) of all evaluation intervals with time interval (T). For example, the total evaluation time may be 1000 hours corresponding to 25 percent of the gear's lifetime and 50 percent of the bearing's lifetime. Remaining component lifetimes are calculated by assuming that the same load histogram that was present up to the i-th interval may also be present in the future. The order in which the different loads are applied in the future might not matter. For the gear, the remaining life is 75 percent. This corresponds to 3000 hours. For the bearing, the remaining life is 50 percent corresponding to an additional 1000 hours.

While embodiments of the invention have been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. For example, the various embodiments of the kinematic, control, electrical, mounting, and user interface subsystems can be used interchangeably without departing from the scope of the invention. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A method, comprising:
determining, by a computing system, a lifetime expectancy of a gearbox located at a first location;
obtaining, by the computing system and from a computing device at the first location, sensor measurements associated with the gearbox;
updating, by the computing system, the lifetime expectancy of the gearbox based on the sensor measurements; and
causing, by the computing system, display of the updated lifetime expectancy of the gearbox.

2. The method of claim 1, wherein the sensor measurements comprise a speed measurement associated with a shaft of the gearbox, and wherein updating the lifetime expectancy of the gearbox is based on the speed measurement.

3. The method of claim 1, wherein the sensor measurements comprise a torque measurement associated with a shaft of the gearbox, and wherein updating the lifetime expectancy of the gearbox is based on the torque measurement.

4. The method of claim 1, wherein the sensor measurements comprise an overhung force measurement associated with an input or output shaft of the gearbox, and wherein updating the lifetime expectancy of the gearbox is based on the overhung force measurement.

5. The method of claim 1, wherein the sensor measurements comprise a vibration measurement associated with the gearbox, and wherein updating the lifetime expectancy of the gearbox is based on the vibration measurement.

6. The method of claim 1, wherein the sensor measurements comprise an oil measurement associated with the gearbox, and wherein updating the lifetime expectancy of the gearbox is based on the oil measurement.

7. The method of claim 1, wherein the sensor measurements comprise a temperature measurement associated with the gearbox, and wherein updating the lifetime expectancy of the gearbox is based on the temperature measurement.

8. The method of claim 1, wherein updating the lifetime expectancy of the gearbox comprises:
updating a lifetime expectancy of a component within the gearbox, wherein the component of the gearbox is a gear, a shaft, or a bearing.

9. The method of claim 8, wherein updating the lifetime expectancy of the component within the gearbox comprises:
calculating gear stresses for the gear of the gearbox;
determining a fatigue limit for the gear of the gearbox based on the gear stresses; and
updating the lifetime expectancy of the gear based on the determined fatigue limit.

10. The method of claim 9, wherein updating the lifetime expectancy of the gear is further based on preexisting gear damage associated with the gear.

11. The method of claim 8, wherein updating the lifetime expectancy of the component within the gearbox comprises:
calculating an incremental bearing damage value associated with the bearing of the gearbox, wherein the incremental bearing damage value is based on an L10 value indicating a number of revolutions that the bearing is expected to withstand under a given load; and
updating the lifetime expectancy of the bearing based on the incremental bearing damage value.

12. The method of claim 1, further comprising:
obtaining, by the computing system and from the computing device, new sensor measurements associated with the gearbox, and
wherein updating the lifetime expectancy of the gearbox comprises:
updating, at a first period of time associated with the sensor measurements, the lifetime expectancy of the gearbox to determine an updated lifetime expectancy based on the sensor measurements; and
updating, at a second period of time associated with the new sensor measurements, the lifetime expectancy of the gearbox to determine a second updated lifetime expectancy based on the updated lifetime expectancy and the new sensor measurements.

13. The method of claim 12, wherein updating the lifetime expectancy of the gearbox further comprises:
continuously updating the lifetime expectancy of the gearbox throughout an entire service life of the gearbox.

14. The method of claim 1, wherein updating the lifetime expectancy of the gearbox comprises:
determining a plurality of lifetime expectancies of a plurality of components within the gearbox based on the sensor measurements associated with the gearbox, wherein the plurality of components within the gearbox comprise one or more gears, one or more shafts, and/or one or more bearings; and
determining a new lifetime expectancy of the gearbox based on a smallest value lifetime expectancy, of the plurality of lifetime expectancies, associated with a particular component, of the plurality of components within the gearbox.

15. The method of claim 1, wherein updating the lifetime expectancy of the gearbox is further based on historical data associated with the gearbox, wherein the historical data comprises data indicating an average gearbox measurement value associated with one or more components of the gearbox, wherein the average gearbox measurement value is based on a plurality of sensor measurements from the one or more sensors that were obtained prior to obtaining the sensor measurements associated with the gearbox.

16. The method of claim 1, further comprising:
generating a load histogram based on historical data associated with a plurality of sensor measurements from the one or more sensors that were obtained prior to obtaining the sensor measurements, wherein the load histogram indicates a plurality of stress ratios associated with the plurality of sensor measurements or a plurality of L10 values associated with the plurality of sensor measurements, and
wherein updating the lifetime expectancy of the gearbox is based on the load histogram.

17. A system, comprising:
a business unit, comprising:
a gearbox, comprising:
one or more sensors configured to provide sensor measurements to a computing device; and
the computing device, wherein the computing device is configured to:
obtain the sensor measurements from the one or more sensors; and
provide the sensor measurements to a back-end computing system; and
the back-end computing system, wherein the back-end computing system is configured to:
determine a lifetime expectancy of the gearbox located at the business unit;
obtain, from the computing device, the sensor measurements associated with the gearbox;
update the lifetime expectancy of the gearbox based on the sensor measurements; and
cause display of the updated lifetime expectancy of the gearbox.

18. The system of claim 17, wherein the back-end computing system is configured to cause display of the updated lifetime expectancy of the gearbox by providing the updated lifetime expectancy of the gearbox to the computing device, and
wherein the computing device is further configured to display the updated lifetime expectancy of the gearbox.

19. The system of claim of claim 17, wherein the back-end computing system comprises a display device, and
wherein the back-end computing system is configured to cause display of the updated lifetime expectancy of the gearbox by displaying the updated lifetime expectancy of the gearbox on the display device.

20. A back-end computing system, comprising:
one or more processors; and
a non-transitory computer-readable medium having processor-executable instructions stored thereon, wherein the processor-executable instructions, when executed by one or more processors, facilitate:
determining a lifetime expectancy of a gearbox located at a first location;
obtaining, from a computing device at the first location, sensor measurements associated with the gearbox;
updating the lifetime expectancy of the gearbox based on the sensor measurements; and
causing display of the updated lifetime expectancy of the gearbox.
